(19) United States
(12) Patent Application Publication
(10) Pub. No.: US 2021/0167424 A1
(43) Pub. Date: Jun. 3, 2021

(54) VISCOSITY REDUCTION FOR IONIC LIQUID ELECTROLYTES

(71) Applicant: Sillion, Inc., Broomfield, CO (US)

(72) Inventors: Tyler Evans, Broomfield, CO (US); Daniela Molina Piper, Broomfield, CO (US); Isaac Scott, Broomfield, CO (US)

(21) Appl. No.: 16/770,524

(22) PCT Filed: Dec. 7, 2018
(86) PCT No.: PCT/US2018/064399

§ 371 Date: Jun. 5, 2020

Related U.S. Application Data
(60) Provisional application No. 62/595,991, filed on Dec. 7, 2017.

(51) Int. Cl. H01M 10/0569; H01M 10/0525; H01M 10/0568; H01M 4/38; H01M 4/62

(52) U.S. Cl. CPC H01M 10/0569; H01M 10/0525; H01M 2004/027; H01M 4/386; H01M 4/622; H01M 10/0568

(57) ABSTRACT

There is disclosed an energy storage device. In an embodiment, the device has an anode including a plurality of active material particles. Each of the plurality of active material particles has a particle size of between about 1 nanometer and about fifty micrometers. One or more of the plurality of active material particles are enclosed by and in contact with a membrane coating permeable to lithium ions, and the membrane coating a thermoplastic polymer treated to a cyclized, non-plastic ladder compound. The device includes a cathode. The device includes an electrolyte coupling the anode to the cathode including a room temperature ionic liquid solvent and at least one wetting agent or viscosity reducing co-solvent and mixtures thereof. Other embodiments are also disclosed.

### REFERENCE TO PENDING PRIOR PATENT APPLICATION

This application claims the benefit of U.S. Provisional Patent Application No. 62/595,991, filed Dec. 7, 2017 by Tyler Evans, et al., for “Viscosity Reduction for Ionic Liquid Electrolytes,” which patent application is hereby incorporated herein by reference.

### FIELD

This disclosure relates to energy storage devices such as lithium-ion electrochemical cells and batteries. More specifically, the disclosure relates to improvements to room temperature ionic liquid electrolytes separately and in combination as used in lithium-ion energy storage devices and batteries.

### BACKGROUND

Ionic liquids are attractive to battery research because they are non-flammable and have much lower vapor pressures and higher electrochemical stability windows than currently employed organic liquid electrolytes. Mixtures of RTIL (room temperature ionic liquids) and conventional organic electrolytes containing 40-60% by volume RTIL are non-flammable. This holds true for the majority of RTIL materials. The ionic liquids considered for battery applications are composed of imidazolium- or sulfonium-based cations, (R. A. Huggins, 2009. Advanced Batteries: Materials Science Aspects, Springer, Stanford, Calif., 323-324) and complex halide anions. Their low melting points are related to lattice energy, the energy required to break the ionic bonds holding the species together. Given their large sizes and low electrical charges, ionic liquids comprised of quaternary ammonium cations have low melting points. (J. H. Shin, W. A. Henderson, S. Passerini, Electrochem. Commun. 5 (2003) 1016.) Quaternary ammonium ions are permanently charged, regardless of pH, and stable across a wide temperature range, allowing stability even as their environment changes chemically and physically. (R. A. Huggins, 2009. Advanced Batteries: Materials Science Aspects, Springer, Stanford, Calif., 323-324. J. H. Shin, W. A. Henderson, S. Passerini, Electrochem. Commun. 5 (2003) 1016.) These materials conduct charge by the transport of one or both of their ions. Ionic conductivity of RTILs is typically on the order of mS cm⁻¹, highly dependent upon the size of the ions and the chain length of the alkyl cation component, and their lithium-ion conductivities are significantly lower than conventional carbonate electrolytes. (J. H. Shin, W. A. Henderson, S. Passerini, Electrochem. Commun. 5 (2003) 1016.) The goal of much early RTIL battery research focused on combining the favorable properties of organic electrolytes with those of ionic liquids. (J. H. Shin, W. A. Henderson, S. Passerini, Electrochem. Commun. 5 (2003) 1016.)

The conductivity of RTILs used in electrochemical applications is significantly lower (typically about half) than electrolytes used in commercialized battery technology. The large size of the ions in RTILs causes them to be more viscous than organic electrolytes, and this hinders ion transport through the electrolyte membrane. Recent work has shown that the addition of ionic liquids to conventional polymer electrolytes provides satisfactory ionic conductivity without affecting their stability. (G. B. Appetecchi, M. Montanino, A. Balducci, S. F. Lux, M. Winter, S. Passerini, J. Power Sources 192 (2009) 599.)

Graphite is not compatible with most RTILs due to the irreversible electrochemical reduction of imidazolium cations on graphite or the cointercalation of the cation species between graphene layers leading to an unstable SEI (solid-electrolyte-interphase) layer or the exfoliation of graphene layers, respectively. This effect is most pronounced at higher potentials. Use of the bis(fluorosulfonyl)imide (FSI⁻) anion has been shown to mitigate this issue. (Liu, N. et al. A pomegranate-inspired nanoscale design for large-volume-change lithium battery anodes. Nature Nanotech. 9, 187-192 (2014).) This is attributed to the ability of the FSI⁻ anion, especially when paired with certain pyrrolidinium (PYR⁺) cations, to form a protective, lithium-ion conducting SEI layer that avoids solvent molecules and stops the cations from penetrating the graphene.

The PYR₁₃ cation aids in the formation of a stable SEI layer on a graphite anode. PYR₁₃FSI also interacts relatively favorably with positive electrode materials, namely those with a layered structure. It has been shown that between a range of FSI⁻ based RTILs, PYR₁₃FSI shows the lowest reactivity and best stability towards LiCoO₂, making it a good candidate for use in conjunction with layered cathode materials. Furthermore, PYR₁₃ is smaller in size than other imidazolium cations suitable for use in battery electrolytes, and this leads to lower viscosity and higher conductivities.

Given the projected growth of Li-ion applications in the next decade, a massive opportunity has arisen for scientists and engineers to develop a battery capable of safely powering devices and vehicles for longer at a lower cost. Such a battery will require a new set of higher energy electrode materials, with the Si/nickel-rich system representing a promising and commercially viable solution to the performance requirements being demanded. In terms of battery safety, ionic liquid electrolytes and solid-state electrolytes are the most promising solutions to the volatility and flammability of existing commercial Li-ion electrolyte materials. Most efforts aimed towards commercializing these materials involve expensive material modifications. To address the performance limitations of existing energy storage electrolyte formulations, SilLion has developed RTIL-based electrolyte compositions capable of enabling high rate performance, enhanced low temperature performance, and long cycle life for use in a range of applications, including electric vehicles.

SilLion has validated its current ionic liquid-based electrolyte formulations and high-energy cell systems in today's commercial battery manufacturing infrastructure, thereby proposing that its technologies will facilitate fast integration and deployment of the technology for maximum impact. SilLion also sits in a unique position, capable of introducing other Li-ion chemistries that could be more geared towards the very high demanded power for certain applications.

Many markets demand a high-rate electrolyte that will enable improved performance over currently available Li-ion batteries in terms of safety, especially if the material enables high-energy electrode systems. Current Li-ion battery technologies provide just over 250 Wh/kg and 700 Wh/L with operational temperatures up to <45° C., and high volatility due to electrolyte reactivity. It is evident that providing safety while improving specific energy is key to providing better battery technology.

SilLion has previously prototyped its “Generation 0” system, comprising NCM811 cathodes, and silicon+graphite composite (30% wt. silicon) anodes targeting high-energy applications (300+ Wh/kg, 700+ Wh/L) with lower power requirements, such as specialty UAV/UUV, DoD wearable batteries, etc. SilLion is currently scaling its “Generation 2” cells comprising NMC[811] cathodes and silicon+graphite composite (60+% silicon) anodes targeting energy disruption at 350+ Wh/kg, and 800+ Wh/L. However, the “Generation 1” cells will need improved electrolytes to really tap into markets needing higher rates and wide temperature range performance, while still maintaining safety at the forefront of the technology. To meet this demand, SilLion has developed an improved electrolyte composition (−40/+75° C. cycling, up to 20 C charging/discharging) to pair with its battery technology, opening doors to many other Li-ion battery industries, such as electric vehicles, grid storage, and other specialty applications. The new electrolyte (SilLion's “Generation 3” electrolyte) is compatible with high rate cell systems outside of SilLion's existing technical focus (micron-Si anodes and nickel-rich NMC cathodes).

Depending on cell design (i.e., active material selection, electrode composition, electrode thickness, etc.) SilLion's technology provides long-term capacity and energy retention at room temperature with rates up to C/2 at 100% (2.7-43V) depth-of-discharge (DoD). SilLion's primary performance limitations, especially at very high rates and low temperatures stem from its RTIL-based electrolyte conductivity (˜4.5 mS cm⁻¹), about half of the conductivity of state-of-the-art carbonate electrolytes, and manifest in relatively low capacities at higher rates (>C) and low temperatures (<0° C.). SilLion's RTIL-based electrolytes perform very favorably stable at higher temperatures and can sustain higher rates at these elevated temperatures due to the changes in viscosity of the electrolytes in these environments. At lower temperatures, the RTIL-based electrolyte suffers drastically, becoming very viscous. FIGS. 1 and 2 depict the strengths as well as limitations of the RTIL-based electrolyte in various environments.

SilLion has made foundational improvements to its baseline RTIL electrolyte already, increasing its conductivity by about 45% (SilLion's “Gen. 2” electrolyte, a.k.a. ClearLyte, achieves 6.5+ mS cm⁻¹). While SilLion has demonstrated record energy densities in high performing cell designs based around high-loaded micron-Si anodes, nickel-rich NMC cathodes, and ionic liquid electrolytes, one key limitation restricts the use of the technology in higher power applications: electrolyte conductivity. RTIL-based electrolyte materials are stigmatized by their ionic conductivities. While alternative pack designs can mitigate this issue by pairing cells in parallel for increased power, SilLion seeks to provide higher rate performance and increased low temperature performance so as to create an appealing Li-ion cell for a range of applications.

SilLion is a leader in providing high performing ionic liquid electrolyte compositions for Li-ion devices. The company's current best RTIL-based electrolyte system, called “ClearLyte,” provides a Li⁺ conductivity of about 75% of state-of-the-art electrolytes. Most RTIL-based electrolytes have significantly lower conductivities (<40% of state-of-the-art electrolyte conductivity). The ClearLyte composition was developed, surprisingly, using co-salt electrolyte additives to limiting cation mobility in SilLion's baseline solvent composition. This essentially allows Li⁺ more freedom of movement, lowering the “cation competition” which so commonly plagues ionic liquid electrolytes and results in very low transference numbers. The use of very small concentrations of this co-salt boosts electrolyte conductivity by >40% to ˜6.6 mS/cm.

This application describes SilLion's ability to improve ionic liquid properties for their utilization in lithium-ion batteries, including viscosity reduction, conductivity improvement, and transference number improvement, through utilization of liquid additives.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1 is an elevated temperature cycling demonstration of micron-Si/RTIL/NMC811 cells with a pure ionic liquid solvent-based electrolyte.

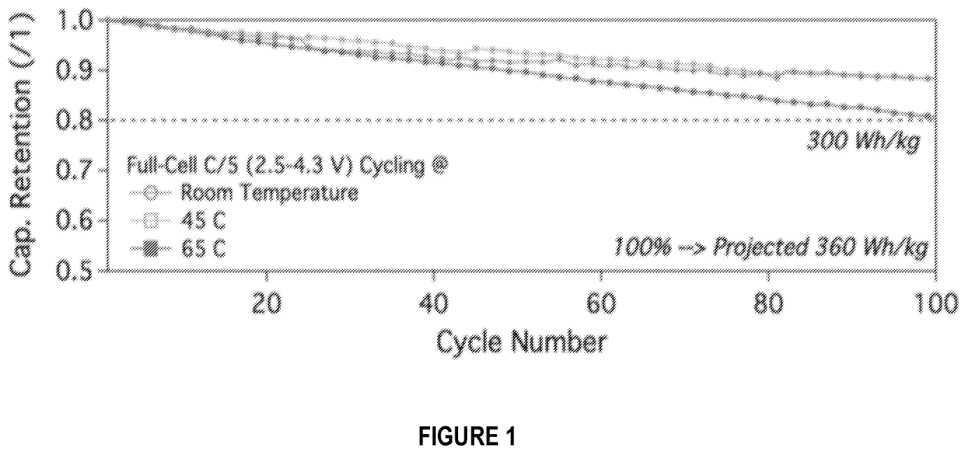

FIG. 2 is a SilLion “Generation 0” cell high/low temp. cycling demonstrations. C/5 (top) and C/10 (bottom), with a pure ionic liquid solvent-based electrolyte.

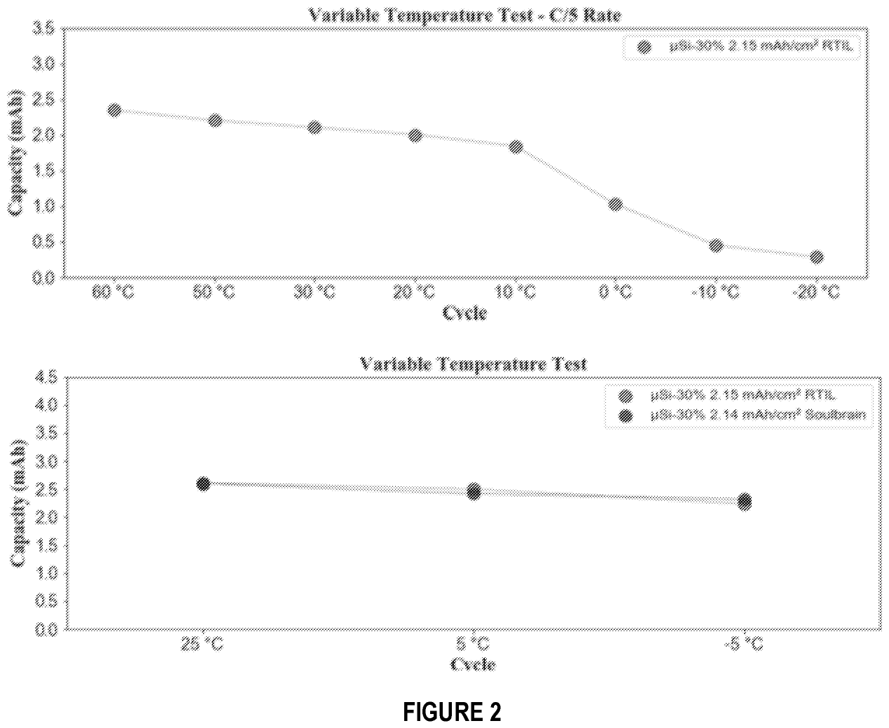

FIG. 3 is a preliminary demonstration of an ether as a viable additive possibility for incorporation in high performing RTIL electrolytes (in SilLion's “Generation 1” cell design).

FIG. 4 is a non-flammability of SilLion's baseline RTIL electrolyte formulation vs. conventional carbonate formulations (top left). Non-flammability of a RTIL/ether 50/50 vol. formulation (top right). Miscibility and wetting of Celgard PP2320 separator using the RTIL/ether 50/50 vol. formulation.

FIG. 5 is a photograph of various electrolyte compositions (shown numbered 1-9, corresponding with vials from left to right in the photo) after 12+ hour exposure to −60 degrees Celsius, showing the ether co-solvent's significant lowering of the electrolyte freezing temperature.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

Contrary to most efforts to improve Li-ion technology, especially with the Si/NMC[811] system, SilLion has taken a “system approach”, creating a technology platform for the next generation of high-performance batteries materials. SilLion's batteries enable the industry's advanced silicon materials for high capacity anodes, high-energy nickel-rich cathodes and non-flammable electrolytes, delivering dramatic enhancements in energy, safety and cost of lithium-ion batteries. (Liu, N. et al. A pomegranate-inspired nanoscale design for large-volume-change lithium battery anodes. Nature Nanotech. 9, 187-192 (2014). Wu, H. et al. Stable cycling of double-walled silicon nanotube battery anodes through solidelectrolyte interphase control. Nature Nanotech. 7, 310-315 (2012). Xu, J. et al. Cathode materials for next generation lithium ion batteries. Nano Energy 2, 439-442 (2013).) SilLion's technology is comprised of an innovative, scalable anode design capable of implementing 5-80 wt. % silicon and electrode-electrolyte combinations capable of delivering Li-ion battery systems which provide >800 Wh/L and 350-400 Wh/kg for <$150/kWh while significantly increasing safety through non-flammable RTIL-based electrolytes. If SilLion can combine this technology with a high rate electrolyte (with 20 C rate pulse power), it will unlock the full system capability demanded by most, if not all, of today's energy storage users and markets.

While SilLion's current progress is appealing, the electrolyte conductivity and viscosity is still insufficient for very high power applications. In order to increase electrolyte conductivity to provide increased rate performance and increased low temperature performance, SilLion can integrate low viscosity solvents, such as fluorinated alkyl ethers, into its electrolytes. The challenge of course lies in finding an appropriate solvent additive that does not detract from the favorable electrode-electrolyte interfacial reactions that stabilize high energy electrode materials. SilLion has identified various additives with low viscosity, high voltage stability, high thermal stability, and high compatibility with high voltage cathodes and high capacity anodes, including SilLion's μSi-cPAN anode.

To demonstrate the validity of this approach, SilLion has conducted initial trials using RTIL and solvent blends. While the use of carbonate co-solvents presents a straightforward and commercially viable path to high rates and high pulse power, these co-solvents limit cycle life when paired with silicon anode materials (other anode materials, such as graphite, provide higher cycle life but are limited in terms of energy density) and show limited safety with high voltage cathode materials such as NMC811.

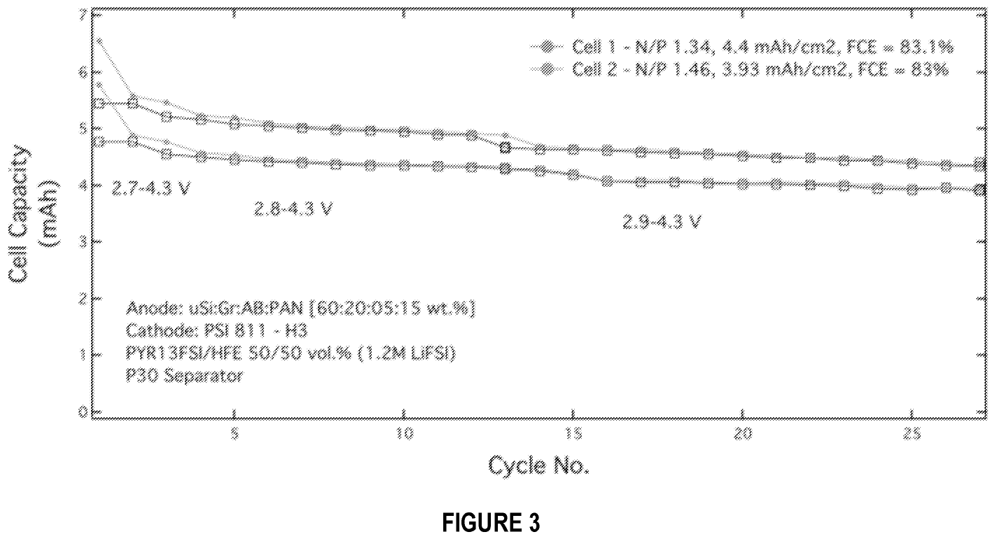

In order to provide enhanced performance at high rates while maintaining the benefits of the ionic liquid materials (compatibility with silicon anodes and high voltage cathode materials), SilLion has identified two very promising classes of co-solvents: fluorinated alkyl ethers and silanes. Ionic liquids with functionalized cations (for lower viscosity and improved wetting) are also of interest. Initial proof-of-concept for these materials is provided in FIG. 3, which presents high performing cycling data of SilLion's high-energy full-cell designs with electrolytes containing 50 vol. % ether co-solvent.

In 2013, Dokko et al. reported that solvate ionic liquids can be diluted with fluorinated alkyl ethers to lower viscosity and increase ionic conductivity without losing the electrolyte's other unique characteristics. (Dokko, K. et al. Solvate ionic liquid electrolyte for Li—S Batteries. J. Electrochem. Soc., 160, A1304 (2013).) Dokko was investigating solvents capable of enhancing ionic conductivity while not interfering with the ionic liquid's suppression of polysulfide dissolution for long cycle life of lithium-sulfur batteries. Fluorinated alkyl ethers, or fluoroalkyl ethers, have high stability against oxidation because they have electron-withdrawing fluorine atoms and are therefore suitable for use as diluents in a range of electrolyte systems, including concentrated LiPF₆/PC and LiBF₄/PC electrolyte systems. (Doi, T. et al. Dilution of highly concentrated LiBF₄/propylene carbonate electrolyte solution with fluoroalkyl ethers for 5-V LiNi_{0.5}Mn_{1.5}O₄ positive electrodes. J. Electrochem. Soc., 164, A6412 (2017).) These works suggest that the interation of such ethers with Li⁺ and FSI⁻ ions is quite weak, in fact suggesting that certain ethers may be “non-solvents” in various electrolyte solutions. This means that the fluoroalkyl ether co-solvents may have little influence on the solvation structure of the electrolyte, unlike conventional carbonate co-solvents. Combined with the high oxidative stability of the fluoroalkyl ether solvent class, SilLion identified these as promising options and formulated a range of electrolyte compositions, including the formulation used to generate the cell performance shown above.

Ether, ether-based, and ether-containing solvents, and silane/siloxane solvents provide excellent balance for the ionic liquid solvents' drawbacks. Ether, silane, and siloxane liquids provide high ionic conductivity, excellent wetting properties, and exceptionally low viscosities all while maintaining wide electrochemical windows and wide liquid-phase temperatures. Most silanes are also non-flammable under conditions suitable for battery cycling. While silanes and ethers are more volatile than ionic liquid solvents, their physicochemical properties provide for improved cycling performance of ionic liquid electrolytes for Li-ion batteries in this invention. In other words, mixing silane and/or ether solvents into the ionic liquid electrolyte formulations provides increased performance without causing negative side effects.

Promising fluoroalkyl ethers include but are not limited to 1,1,2,2-tetrafluoroethyl-2,2,3,3-tetrafluoropropyl ether, 1,1,2,3,3,3-hexafluoropropyl-2,2,3,3-tetrafluoropropyl ether, 2,2,3,3,3-pentafluoropropyl-1,1,2,2-tetrafluoroethyl ether, 1,1,2,2-tetrafluoroethyl-2,2,2-trifluoroethyl ether, 1,1,2,2-tetrafluoroethyl-2,2,3,3-tetrafluoropropyl ether, methyl ether, tetrafluoropropyl-propylene carbonate-ether, and 1,1,2,2-tetrafluoroethyl ethyl ether. Other promising ethers include 2-methyl tetrahydrofuran, 1,3-dioxolane, 1,4-dioxane, 1,2-dimethoxyethane, 1,2-diethoxyethane, 1,2-dibutoxyethane, methyl nonafluorobutyl ether, ethyl nonafluorobutyl ether, bis(2,2,2-trifluoroethyl) ether, 2-trifluoromethyl hexafluoropropyl methyl ether, 2-trifluoromethyl hexafluoropropyl ethyl ether, 2-trifluoromethyl hexafluoropropyl propyl ether, 3-trifluoro octafluorobutyl methyl ether, 3-trifluoro octafluorobutyl ethyl ether, 3-trifluoro octafluorobutyl propyl ether, 4-trifluorodecafluoropenthyl methyl ether, 4-trifluorodecafluoropenthyl ethyl ether, 4-trifluorodecafluoropenthyl propyl ether, 5-trifluorododecafluorohexyl methyl ether, 5-trifluorododecafluorohexyl ethyl ether, 5-trifluorododecafluorohexyl propyl ether, 6-trifluorotetradecafluoroheptyl methyl ether, 6-trifluorotetradecafluoroheptyl ethyl ether, 6-trifluorotetradecafluoroheptyl propyl ether, 7-trifluorohexadecafluorooctyl methyl ether, 7-trifluorohexadecafluorooctyl ethyl ether, and 7-trifluorohexadecafluorohexyl octyl ether, dimethoxy methane, 1,2-dimethoxy ethane, digryme, trigryme, 1,3-dioxolane, and tetrahydrofuran.

Promising silane or siloxane co-solvents include but are not limited to phenyltrimethoxysilane, ethyltrimethoxysilane, pentafluorophenyltrimethoxylsilane, and phenethyltris(trimethylsiloxy)silane, Tris(pentafluorophenyl)silane, tris(trimethylsilyl)phosphate, tris(trimethylsilyl)phosphite, tris(trimethylsilyl)borate, bis(methoxytriethyleneoxypropyl)-tetramethyldisiloxane, and silanes of the following formulae:

(CH₃)₃SiO(CH₂CH₂O)₂CH₃, (CH₃)₃SiO(CH₂CH₂O)₃CH₃, (CH₃)₃SiO(CH₂CH₂O)₄CH₃, (CH₃)₃SiO(CH₂CH₂O)₅CH₃, (CH₃)₃SiO(CH₂CH₂O)₆CH₃, (CH₃)₃SiO(CH₂CH₂O)₇CH₃; (CH₃)₃SiCH₂O(CH₂CH₂O)₂CH₃, (CH₃)₃SiCH₂O(CH₂CH₂O)₃CH₃, (CH₃)₃SiCH₂O(CH₂CH₂O)₄CH₃, (CH₃)₃SiCH₂O(CH₂CH₂O)₅CH₃, (CH₃)₃SiCH₂O(CH₂CH₂O)₆CH₃, (CH₃)₃SiCH₂O(CH₂CH₂O)₇CH₃, (CH₃)₃Si(CH₂)₃O(CH₂CH₂O)₂CH₃, (CH₃)₃Si(CH₂)₃O(CH₂CH₂O)₃CH₃, (CH₃)₃Si(CH₂)₃O(CH₂CH₂O)₄CH₃, (CH₃)₃Si(CH₂)₃O(CH₂CH₂O)₅CH₃, (CH₃)₂Si[O(CH₂CH₂O)₂CH₃]₂, (CH₃)₂Si[O(CH₂CH₂O)₃CH₃]₂, (CH₃)₂Si[O(CH₂CH₂O)₄CH₃]₂, (CH₃)₂Si[O(CH₂CH₂O)₅CH₃]₂; CH₃Si[O(CH₂CH₂O)₂CH₃]₃, CH₃Si[O(CH₂CH₂O)₃CH₃]₃, CH₃Si[O(CH₂CH₂O)₄CH₃]₃; Si[O(CH₂CH₂O)₂CH₃]₄, Si[O(CH₂CH₂O)₃CH₃]₄, (CH₃)₂Si[O(CH₂CH₂O)₂CH₃][(CH₂)₃O(CH₂CH₂O)₂CH₃], (CH₃)₂Si[O(CH₂CH₂O)₃CH₃][(CH₂)₃O(CH₂CH₂O)₃CH₃], (CH₃)₂Si[O(CH₂CH₂O)₄CH₃][(CH₂)₃O(CH₂CH₂O)₄CH₃], (CH₃)₂Si[O(CH₂CH₂O)₅CH₃][(CH₂)₃O(CH₂CH₂O)₅CH₃].

Exemplary siloxanes include but are not limited to solvents of the following formulae:

(CH₃)₃SiO(CH₂CH₂O)ₙCH₃, (CH₃)₃SiCH₂O(CH₂CH₂O)ₙCH₃; (CH₃)₃Si(CH₂)₃O(CH₂CH₂O)_{n′}CH₃; (CH₃)₂Si[O(CH₂CH₂O)ₙ′CH₃]₂; CH₃Si[O(CH₂CH₂O)ₚCH₃]₃, Si[O(CH₂CH₂O)ₚCH₃]₄; (CH₃)₂Si[O(CH₂CH₂O)_{n′}CH₃][(CH₂)₃O(CH₂CH₂O)_{n′}CH₃]; (CH₃)₃SiOR; (CH₃)₃Si(CH₂)₃OR; CH₃O(CH₂CH₂O)ₙSi(CH₃)₂O(CH₃)₂SiO(CH₂CH₂O)ₙCH₃, CH₃O(CH₂CH₂O)ₙCH₂Si(CH₃)₂O(CH₃)₂SiCH₂O(CH₂CH₂O)ₙCH₃, CH₃O(CH₂CH₂O)ₙ(CH₂)₃Si(CH₃)₂O(CH₃)₂Si(CH₂)₃O(CH₂CH₂O)ₙCH₃, (CH₃)₃SiO(CH₃)₂Si(CH₂)₃O(CH₂CH₂O)ₙCH₃, (CH₃)₃SiO(CH₃)₂Si(CH₂)₂O(CH₂CH₂O)ₙCH₃, (CH₃)₃SiO(CH₃)₂SiO(CH₂CH₂O)ₙCH₃, (CH₃)₃SiO(CH₃)₂SiOR; ROSi(CH₃)₂O(CH₃)₂SiO—R; (CH₃)₃SiO(CH₃)₂Si(CH₂)₃OR; RO(CH₂)₃Si(CH₃)₂O(CH₃)₂Si(CH₂)₃OR; CH₃O(CH₂CH₂O)ₙSi(CH₃)₂OSi(CH₃)₂O(CH₃)₂SiO(CH₂CH₂O)ₙCH₃, CH₃O(CH₂CH₂O)_{n′}(CH₂)₃Si(CH₃)₂OSi(CH₃)₂O(CH₃)₂Si(CH₂)₃O(CH₃)₂Si—(OCH₂CH₂)_{n′}OCH₃, [(CH₃)₃SiO]₂Si(CH₃)O(CH₂CH₂O)ₙCH₃, [(CH₃)₃SiO]₂Si(CH₃)(CH₂)₃O(CH₂CH₂O)ₙCH₃, [(CH₃)₃SiO]₂Si(CH₃)O(CH₂CH₂O)ₙ(CH₃)Si[OSi(CH₃)₃]₂, ROSi(CH₃)₂OSi(CH₃)₂O(CH₃)₂SiOR, ROSi(CH₃)₂OSi(CH₃)₂OSi(CH₃)₃, RO(CH₂)₃Si(CH₃)₂OSi(CH₃)₂O(CH₃)₂Si(CH₂)₃OR, RO(CH₂)₃Si(CH₃)₂OSi(CH₃)₂OSi(CH₃)₃; ROSi(CH₃)₂OSi(CH₃)₂O(CH₃)₂SiO(CH₂CH₂)ₙCH₃, or RO(CH₂)₃Si(CH₃)₂OSi(CH₃)₂O(CH₃)₂Si(CH₂)₃O(CH₂CH₂)ₙCH₃, CH₃O(CH₂CH₂O)₂Si(CH₃)₂O(CH₃)₂SiO(CH₂CH₂O)₂CH₃, CH₃O(CH₂CH₂O)₃Si(CH₃)₂O(CH₃)₂SiO(CH₂CH₂O)3CH₃, CH3O(CH₂CH₂O)₄Si(CH₃)₂O(CH₃)₂SiO(CH₂CH₂O)₄CH₃, CH₃O(CH₂CH₂O)₅Si(CH₃)₂O(CH₃)₂SiO(CH₂CH₂O)₅CH₃, CH₃O(CH₂CH₂O)₆Si(CH₃)₂O(CH₃)₂SiO(CH₂CH₂O)₆CH₃, CH₃O(CH₂CH₂O)₇Si(CH₃)₂O(CH₃)₂SiO(CH₂CH₂O)₇CH₃; CH₃O(CH₂CH₂O)₂CH₂—Si(CH₃)₂O(CH₃)₂Si—CH₂O(CH₂CH₂O)₂CH₃, CH₃O(CH₂CH₂O)₂CH₂Si(CH₃)₃O(CH₃)₂Si—CH₂O(CH₂CH₂O)₃CH₃, CH₃O(CH₂CH₂O)₄CH₂Si(CH₃)₂O(CH₃)₂SiCH₂O(CH₂CH₂O)₄CH₃, CH₃O(CH₂CH₂O)₅CH₂Si(CH₃)₂O(CH₃)₂SiCH₂O(CH₂CH₂O)₅CH₃, CH₃O(CH₂CH₂O)₆CH₂ Si(CH₃)₂O(CH₃)₂SiCH₂O(CH₂CH₂O)₆CH₃, CH₃O(CH₂CH₂O)₇CH₂Si(CH₃)₂O(CH₃)₂Si—CH₂O(CH₂CH₂O)₇CH₃, CH₃O(CH₂CH₂O)₂(CH₂)₃Si(CH₃)₂O(CH₃)₂Si—(CH₂)₃O(CH₂CH₂O)₂CH₃, CH₃O(CH₂CH₂O)₃(CH₂)₃—Si(CH₃)₂O(CH₃)₂Si—(CH₂)₃O(CH₂CH₂O)₃CH₃, CH₃O(CH₂CH₂O)₄(CH₂)₃—Si(CH₃)₂O(CH₃)₂Si—(CH₂)₃O(CH₂CH₂O)₄CH₃, CH₃O(CH₂CH₂O)₅(CH₂)₃—Si(CH₃)₂O(CH₃)₂Si—(CH₂)₃O(CH₂CH₂O)₅CH₃, CH₃O(CH₂CH₂O)₆(CH₂)₃—Si(CH₃)₂O(CH₃)₂Si—(CH₂)₃O(CH₂CH₂O)₆CH₃, CH₃O(CH₂CH₂O)₇(CH₂)₃Si(CH₃)₂O(CH₃)₂Si—(CH₂)₃O(CH₂CH₂O)₇CH₃; (CH₃)₃SiO(CH₃)₂Si—(CH₂)₃O(CH₂CH₂O)₂CH₃, (CH₃)₃SiO(CH₃)₂Si—(CH₂)₃O(CH₂CH₂O)₃CH₃, (CH₃)₃SiO(CH₃)₂Si—(CH₂)₃O(CH₂CH₂O)₄CH₃, (CH₃)₃SiO(CH₃)₂Si—(CH₂)₃O(CH₂CH₂O)₅CH₃, (CH₃)₃SiO(CH₃)₂Si—(CH₂)₃O(CH₂CH₂O)₆CH₃, (CH₃)₃SiO(CH₃)₂Si—(CH₂)₃O(CH₂CH₂O)₇CH₃; (CH₃)₃SiO(CH₃)₂Si—(CH₂)₂O(CH₂CH₂O)₂CH₃, (CH₃)₃SiO(CH₃)₂Si—(CH₂)₂O(CH₂CH₂O)₃CH₃, (CH₃)₃SiO(CH₃)₂Si—(CH₂)₂O(CH₂CH₂O)₄CH₃, (CH₃)₃SiO(CH₃)₂Si—(CH₂)₂O(CH₂CH₂O)₅CH₃, (CH₃)₃SiO(CH₃)₂Si—(CH₂)₂O(CH₂CH₂O)₆CH₃, (CH₃)₃SiO(CH₃)₂Si—(CH₂)₂O(CH₂CH₂O)₇CH₃; (CH₃)₃SiO(CH₃)₂SiO(CH₂CH₂O)₂CH₃, (CH₃)₃SiO(CH₃)₂SiO(CH₂CH₂O)₃CH₃, (CH₃)₃SiO(CH₃)₂SiO(CH₂CH₂O)₄CH₃, (CH₃)₃SiO(CH₃)₂SiO(CH₂CH₂O)₅CH₃, (CH₃)₃SiO(CH₃)₂SiO(CH₂CH₂O)₆CH₃, (CH₃)₃SiO(CH₃)₂SiO(CH₂CH₂O)₇CH₃, CH₃O(CH₂CH₂O)₂Si(CH₃)₂OSi(CH₃)₂O(CH₃)₂SiO(CH₂CH₂O)₂CH₃, CH₃O(CH₂CH₂O)₃Si(CH₃)₂OSi(CH₃)₂O(CH₃)₂SiO(CH₂CH₂O)₃CH₃, CH₃O(CH₂CH₂O)₄Si(CH₃)₂OSi(CH₃)₂O(CH₃)₂SiO(CH₂CH₂O)₄CH₃, CH₃O(CH₂CH₂O)₅Si(CH₃)₂OSi(CH₃)₂O(CH₃)₂SiO(CH₂CH₂O)₅CH₃, CH₃O(CH₂CH₂O)₆Si(CH₃)₂OSi(CH₃)₂O(CH₃)₂SiO(CH₂CH₂O)₆CH₃, CH₃O(CH₂CH₂O)₇Si(CH₃)₂OSi(CH₃)₂O(CH₃)₂SiO(CH₂CH₂O)₇CH₃; CH₃O(CH₂CH₂O)₂(CH₂)₃Si(CH₃)₂OSi(CH₃)₂O(CH₃)₂Si(CH₂)₃O(CH₃)₂SiO(CH₂CH₂O)₂CH₃, CH₃O(CH₂CH₂O)₃(CH₂)₃Si(CH₃)₂OSi(CH₃)₂O(CH₃)₂Si(CH₂)₃O(CH₃)₂SiO(CH₂CH₂O)₃CH₃, CH₃O(CH₂CH₂O)₄(CH₂)₃Si(CH₃)₂OSi(CH₃)₂O(CH₃)₂Si(CH₂)₃O(CH₃)₂SiO(CH₂CH₂O)₄CH₃, CH₃O(CH₂CH₂O)₅(CH₂)₃Si(CH₃)₂OSi(CH₃)₂O(CH₃)₂Si(CH₂)₃O(CH₃)₂SiO(CH₂CH₂O)₅CH₃; [(CH₃)₃SiO]₂Si(CH₃)O(CH₂CH₂O)₂CH₃, [(CH₃)₃SiO]₂Si(CH₃)O(CH₂CH₂O)₃CH₃, [(CH₃)₃SiO]₂Si(CH₃)O(CH₂CH₂O)₄CH₃, [(CH₃)₃SiO]₂Si(CH₃)O(CH₂CH₂O)₅CH₃, [(CH₃)₃SiO]₂Si(CH₃)O(CH₂CH₂O)₆CH₃, [(CH₃)₃SiO]₂Si(CH₃)O(CH₂CH₂O)₇CH₃, [(CH₃)₃SiO]₂Si(CH₃)(CH₂)₃O(CH₂CH₂O)₂CH₃, [(CH₃)₃SiO]₂Si(CH₃)(CH₂)₃O(CH₂CH₂O)₃CH₃, [(CH₃)₃SiO]₂Si(CH₃)(CH₂)₃O(CH₂CH₂O)₄CH₃, [(CH₃)₃SiO]₂Si(CH₃)(CH₂)₃O(CH₂CH₂O)₅CH₃, [(CH₃)₃SiO]₂Si(CH₃)(CH₂)₃O(CH₂CH₂O)₆CH₃, [(CH₃)₃SiO]₂Si(CH₃)(CH₂)₃O(CH₂CH₂O)₇CH₃, [(CH₃)₃SiO]₂Si(CH₃)O(CH₂CH₂O)₂(CH₃)Si[OSi(CH₃)₃]₂, [(CH₃)₃SiO]₂Si(CH₃)O(CH₂CH₂O)₃(CH₃)Si[OSi(CH₃)₃]₂, [(CH₃)₃SiO]₂Si(CH₃)O(CH₂CH₂O)₄(CH₃)Si[OSi(CH₃)₃]₂, [(CH₃)₃SiO]₂Si(CH₃)O(CH₂CH₂O)₅(CH₃)Si[OSi(CH₃)₃]₂, [(CH₃)₃SiO]₂Si(CH₃)O(CH₂CH₂O)₆(CH₃)Si[OSi(CH₃)₃]₂, [(CH₃)₃SiO]₂Si(CH₃)O(CH₂CH₂O)₇(CH₃)Si[OSi(CH₃)₃]₂, R—OSi(CH₃)₂OSi(CH₃)₂O(CH₃)₂SiO—R, R—OSi(CH₃)₂OSi(CH₃)₂OSi(CH₃)₃, RO(CH₂)₃Si(CH₃)₂OSi(CH₃)₂O(CH₃)₂Si(CH₂)₃O—R, RO(CH₂)₃Si(CH₃)₂OSi(CH₃)₂OSi(CH₃)₃; R—OSi(CH₃)₂OSi(CH₃)₂O(CH₃)₂SiO(CH₂CH₂)ₙCH₃, or RO(CH₂)₃Si(CH₃)₂OSi(CH₃)₂O(CH₃)₂Si(CH₂)₃O(CH₂CH₂)ₙCH₃, wherein
R is a carbonate group; n is 2, 3, 4, 5, 6, or 7;
n′ is 2, 3, 4, or 5;
p is 2, 3, or 4; and
p′ is 2 or 3.

While ionic liquids containing the pyrrolidinium cation provide for high performing electrolyte formulations for lithium-ion and lithium metal rechargeable cells, ionic liquid solvents containing pyrrolidinium are relatively viscous compared to traditionally used carbonate solvents. This results in relatively weak power capability and poor performance at low temperatures. Functionalizing the pyrrolidinium cation can weaken its interactions with other ionic constituents in the electrolyte, causing the liquid to become less viscous and lowering cation transport competition (i.e., improving lithium transference). Certain functional groups, when substituted onto the pyrrolidinium cation ring, address the problems of low temperature performance and viscosity without causing detriment to the ionic liquids advantageous qualities of non-flammability, thermal stability, and wide electrochemical window. The functional groups are typically appended onto a nitrogen in the heterocyclic pyrrolidinium cation, replacing existing functional groups of the more common pyrrolidinum cations used in lithium-ion batteries. For example, an ester group can be added, wherein the ester group causes the liquid to have a higher dielectric constant (i.e., better lithium ion solvation). In another example, an ether functional group produces a similar effect. The introduction of a polar ether functional group to the pyrrolidinium cation in an ionic liquid-based electrolyte lowers the mobility of the cation and thereby increases the lithium transference number. This results in improved high power performance. Furthermore, ether and ether-based functional groups lower the activation energy and viscosity of pyrrolidinium-based ionic liquids, lowering surface tension and increasing the total free volume (decreasing the density) of the liquid. This is critical to the transport of adjacent molecules, including lithium ions.

Promising ionic liquids, with functionalized pyrrolidinium cations, include but are not limited to ionic liquids comprising a pyrrolidinium cation wherein one or more of the atoms in the heterocyclic ring is substituted with one or more moieties selected from the group consisting of halides, oxygen, nitrogen, sulfur, phosphorus, alkanes, esters, ethers, ketones, carbonyls, alkoxyalkanes, alkenes, alkynes, aryls, nitriles, silanes, sulfones, thiols, phenols, hydroxyls, amines, imides, aldehydes, carboxylic acids, carbonates, and acid anhydrides; and wherein any of the carbon or hydrogen atoms in the above moieties are further substituted with halides, oxygen, nitrogen, sulfur, phosphorus, alkanes, esters, ethers, ketones, carbonyls, alkoxyalkanes, alkenes, alkynes, aryls, nitriles, silanes, sulfones, thiols, phenols, hydroxyls, amines, imides, aldehydes, carboxylic acids, carbonates, and acid anhydrides.

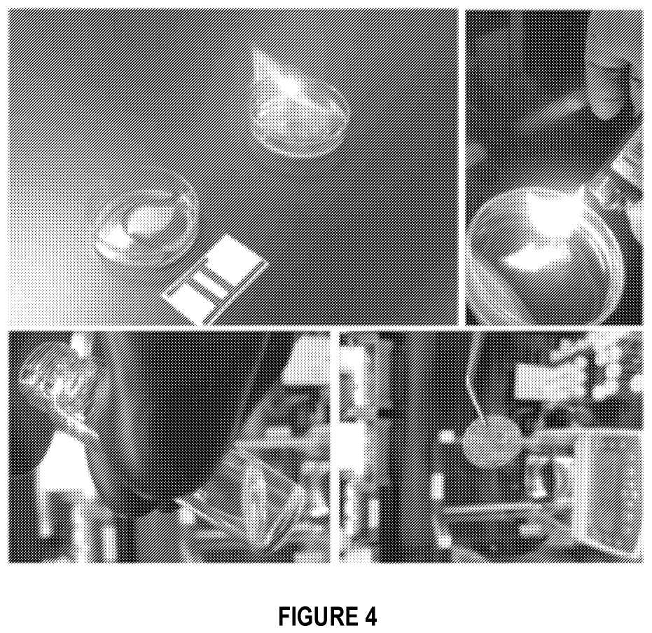

Given the demand for improved safety, along with other niche application targets and ongoing development projects at SilLion, the SilLion team completed an initial flammability test with its ether-RTIL electrolyte solutions. FIG. 4 presents the non-flammability of SilLion's new ether-RTIL electrolyte formulations (top right panel) along with their ability to wet conventional Celgard polyolefin separator materials (bottom right panel).

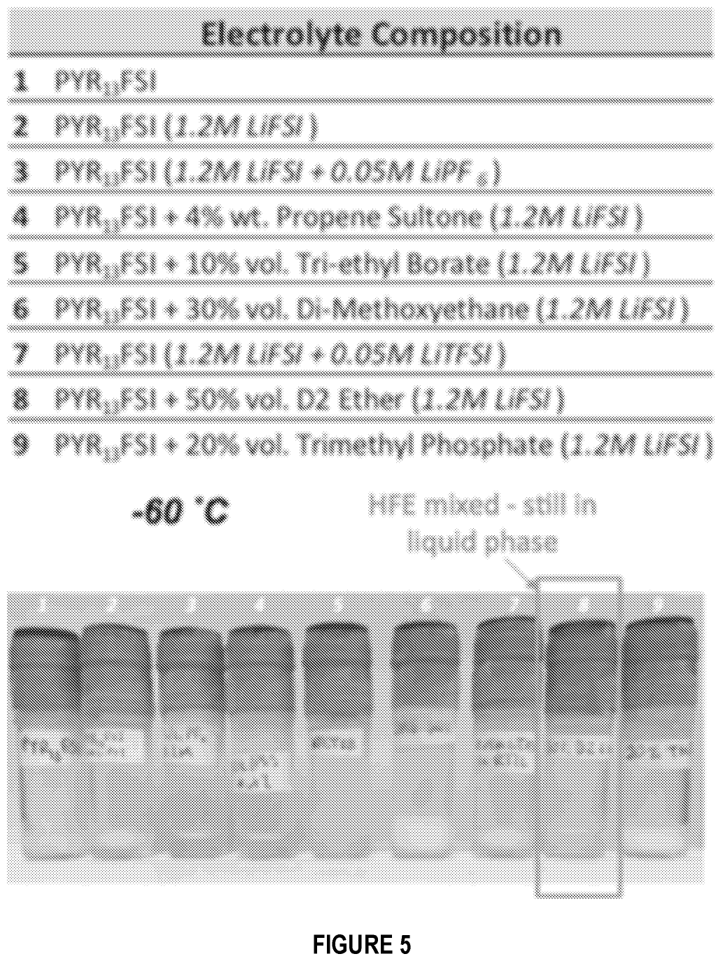

These materials also significantly reduce the freezing temperature of SilLion's baseline electrolyte formulations, as shown in FIG. 5, which presents the ability of the 50 vol. % ether electrolyte to remain a low viscosity liquid at temperatures as low as −60° C. while other compositions (including sultone, borate, DME, and phosphate solvents) freeze at about −10 to −20° C. While not shown, the ether co-solvent provides maintenance of the electrolyte's liquid state to temperatures as low as −80° C. (limit of SilLion's thermal chambers).

This preliminary data set is highly encouraging for SilLion's development goals. With a boiling point of >90° C., the ether co-solvent is an attractive solvent for a wide operational temperature window. However, SilLion would suggest that in-depth safety study will be required to verify the scaled safety performance of cells containing the additive given its relatively high volatility when compared to pure ionic liquid-based compositions.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. An energy storage device comprising:
an anode including a plurality of active material particles, each of the plurality of active material particles having a particle size of between about 1 nanometer and about fifty micrometers, wherein one or more of the plurality of active material particles are enclosed by and in contact with a membrane coating permeable to lithium ions, the membrane coating a thermoplastic polymer treated to a cyclized, non-plastic ladder compound;
a cathode; and
an electrolyte coupling the anode to the cathode including a room temperature ionic liquid solvent and at least one wetting agent or viscosity reducing co-solvent and mixtures thereof.

2. The energy storage device of claim 1, wherein the anode comprises a plurality of active material particles comprising a plurality of silicon particles.

3. The energy storage device of claim 1, wherein the electrolyte comprises at least one of a bisfluorosulfonylimide solvent anion and a lithium bisfluorosulfonylimide salt.

4. The energy storage device of claim 1, wherein the viscosity reducing solvent comprises a functionalized pyrrolidinum cation.

5. The energy storage device of claim 4, wherein one or more of the atoms in the heterocyclic ring of the pyrrolidinium cation is substituted with one or more moieties selected from the group consisting of halides, oxygen, nitrogen, sulfur, phosphorus, alkanes, esters, ethers, ketones, carbonyls, alkoxyalkanes, alkenes, alkynes, aryls, nitriles, silanes, sulfones, thiols, phenols, hydroxyls, amines, imides, aldehydes, carboxylic acids, carbonates, and acid anhydrides; and
wherein any of the carbon or hydrogen atoms in the above moieties are further substituted with halides, oxygen, nitrogen, sulfur, phosphorus, alkanes, esters, ethers, ketones, carbonyls, alkoxyalkanes, alkenes, alkynes, aryls, nitriles, silanes, sulfones, thiols, phenols, hydroxyls, amines, imides, aldehydes, carboxylic acids, carbonates, and acid anhydrides.

6. The energy storage device of claim 1, wherein the viscosity reducing solvent comprises a silane or siloxane solvent.

7. The energy storage device of claim 6, wherein the silane or siloxane solvent comprises at least one of phenyltrimethoxysilane, ethyltrimethoxysilane, pentafluorophenyltrimethoxylsilane, and phenethyltris(trimethylsiloxy)silane, Tris(pentafluorophenyl)silane, tris(trimethylsilyl)phosphate, tris(trimethylsilyl)phosphite, tris(trimethylsilyl)borate, bis(methoxytriethyleneoxypropyl)-tetra methyldisiloxane, silanes of the formulae:
(CH₃)₃SiO(CH₂CH₂O)₂CH₃, (CH₃)₃SiO(CH₂CH₂O)₃CH₃, (CH₃)₃SiO(CH₂CH₂O)₄CH₃, (CH₃)₃SiO(CH₂CH₂O)₅CH₃, (CH₃)₃SiO(CH₂CH₂O)₆CH₃, (CH₃)₃SiO(CH₂CH₂O)₇CH₃; (CH₃)₃SiCH₂O(CH₂CH₂O)₂CH₃, (CH₃)₃SiCH₂O(CH₂CH₂O)₃CH₃, (CH₃)₃SiCH₂O(CH₂CH₂O)₄CH₃, (CH₃)₃SiCH₂O(CH₂CH₂O)₅CH₃, (CH₃)₃SiCH₂O(CH₂CH₂O)₆CH₃, (CH₃)₃SiCH₂O(CH₂CH₂O)₇CH₃, (CH₃)₃Si(CH₂)₃O(CH₂CH₂O)₂CH₃, (CH₃)₃Si(CH₂)₃O(CH₂CH₂O)₃CH₃, (CH₃)₃Si(CH₂)₃O(CH₂CH₂O)₄CH₃, (CH₃)₃Si(CH₂)₃O(CH₂CH₂O)₅CH₃, (CH₃)₂Si[O(CH₂CH₂O)₂CH₃]₂, (CH₃)₂Si[O(CH₂CH₂O)₃CH₃]₂, (CH₃)₂Si[O(CH₂CH₂O)₄CH₃]₂, (CH₃)₂Si[O(CH₂CH₂O)₅CH₃]₂; CH₃Si[O(CH₂CH₂O)₂CH₃]₃, CH₃Si[O(CH₂CH₂O)₃CH₃]₃, CH₃Si[O(CH₂CH₂O)₄CH₃]₃; Si[O(CH₂CH₂O)₂CH₃]₄, Si[O(CH₂CH₂O)₃CH₃]₄; (CH₃)₂Si[O(CH₂CH₂O)₂CH₃][(CH₂)₃⁰(CH₂CH₂O)₂CH₃], (CH₃)₂Si[O(CH₂CH₂O)₃CH₃][(CH₂)₃O(CH₂CH₂O)₃CH₃], (CH₃)₂Si[O(CH₂CH₂O)₄CH₃][(CH₂)₃O(CH₂CH₂O)₄CH₃], (CH₃)₂Si[O(CH₂CH₂O)₅CH₃][(CH₂)₃O(CH₂CH₂O)₅CH₃],
and siloxanes of the formulae:
(CH₃)₃SiO(CH₂CH₂O)ₙCH₃, (CH₃)₃SiCH₂O(CH₂CH₂O)ₙCH₃; (CH₃)₃Si(CH₂)₃O(CH₂CH₂O)_{n′}CH₃; (CH₃)₂Si[O(CH₂CH₂O)_{n′}CH₃]₂; CH₃Si[O(CH₂CH₂O)ₚCH₃]₃, Si[O(CH₂CH₂O)ₚCH₃]₄; (CH₃)₂Si[O(CH₂CH₂O)_{n′}CH₃][(CH₂)₃O(CH₂CH₂O)_{n′}CH₃]; (CH₃)₃SiOR; (CH₃)₃Si(CH₂)₃OR; CH₃O(CH₂CH₂O)ₙSi(CH₃)₂O(CH₃)₂SiO(CH₂CH₂O)ₙCH₃, CH₃O(CH₂CH₂O)ₙCH₂Si(CH₃)₂O(CH₃)₂SiCH₂O(CH₂CH₂O)ₙCH₃, CH₃O(CH₂CH₂O)ₙ(CH₂)₃Si(CH₃)₂O(CH₃)₂Si(CH₂)₃O(CH₂CH₂O)ₙCH₃, (CH₃)₃SiO(CH₃)₂Si(CH₂)₃O(CH₂CH₂O)ₙCH₃, (CH₃)₃SiO(CH₃)₂Si(CH₂)₂O(CH₂CH₂O)ₙCH₃, (CH₃)₃SiO(CH₃)₂SiO(CH₂CH₂O)ₙCH₃, (CH₃)₃SiO(CH₃)₂SiOR; ROSi(CH₃)₂O(CH₃)₂SiO—R; (CH₃)₃SiO(CH₃)₂Si(CH₂)₃OR; RO(CH₂)₃Si(CH₃)₂O(CH₃)₂Si(CH₂)₃OR; CH₃O(CH₂CH₂O)ₙSi(CH₃)₂OSi(CH₃)₂O(CH₃)₂SiO(CH₂CH₂O)ₙCH₃, CH₃O(CH₂CH₂O)_{n′}(CH₂)₃Si(CH₃)₂OSi(CH₃)₂O(CH₃)₂Si(CH₂)₃O(CH₃)₂Si—(OCH₂CH₂)_{n′}OCH₃, [(CH₃)₃SiO]₂Si(CH₃)O(CH₂CH₂O)ₙCH₃, [(CH₃)₃SiO]₂Si(CH₃)(CH₂)₃O(CH₂CH₂O)ₙCH₃, [(CH₃)₃SiO]₂Si(CH₃)O(CH₂CH₂O)ₙ(CH₃)Si[OSi(CH₃)₃]₂, ROSi(CH₃)₂OSi(CH₃)₂O(CH₃)₂SiOR, ROSi(CH₃)₂OSi(CH₃)₂OSi(CH₃)₃, RO(CH₂)₃Si(CH₃)₂OSi(CH₃)₂O(CH₃)₂Si(CH₂)₃OR, RO(CH₂)₃Si(CH₃)₂OSi(CH₃)₂OSi(CH₃)₃; ROSi(CH₃)₂OSi(CH₃)₂O(CH₃)₂SiO(CH₂CH₂)ₙCH₃, or RO(CH₂)₃Si(CH₃)₂OSi(CH₃)₂O(CH₃)₂Si(CH₂)₃O(CH₂CH₂)ₙCH₃, CH₃O(CH₂CH₂O)₂Si(CH₃)₂O(CH₃)₂SiO(CH₂CH₂O)₂CH₃, CH₃O(CH₂CH₂O)₃Si(CH₃)₂O(CH₃)₂SiO(CH₂CH₂O)3CH₃, CH3O(CH₂CH₂O)₄Si(CH₃)₂O(CH₃)₂SiO(CH₂CH₂O)₄CH₃, CH₃O(CH₂CH₂O)₅Si(CH₃)₂O(CH₃)₂SiO(CH₂CH₂O)₅CH₃, CH₃O(CH₂CH₂O)₆Si(CH₃)₂O(CH₃)₂SiO(CH₂CH₂O)₆CH₃, CH₃O(CH₂CH₂O)₇Si(CH₃)₂O(CH₃)₂SiO(CH₂CH₂O)₇CH₃; CH₃O(CH₂CH₂O)₂CH₂—Si(CH₃)₂O(CH₃)₂Si—CH₂O(CH₂CH₂O)₂CH₃, CH₃O(CH₂CH₂O)₂CH₂Si(CH₃)₃O(CH₃)₂Si—CH₂O(CH₂CH₂O)₃CH₃, CH₃O(CH₂CH₂O)₄CH₂Si(CH₃)₂O(CH₃)₂SiCH₂O(CH₂CH₂O)₄CH₃, CH₃O(CH₂CH₂O)₅CH₂Si(CH₃)₂O(CH₃)₂SiCH₂O(CH₂CH₂O)₅CH₃, CH₃O(CH₂CH₂O)₆CH₂—Si(CH₃)₂O(CH₃)₂SiCH₂O(CH₂CH₂O)₆CH₃, CH₃O(CH₂CH₂O)₇CH₂Si(CH₃)₂O(CH₃)₂Si—CH₂O(CH₂CH₂O)₇CH₃, CH₃O(CH₂CH₂O)₂(CH₂)₃Si(CH₃)₂O(CH₃)₂Si—(CH₂)₃O(CH₂CH₂O)₂CH₃, CH₃O(CH₂CH₂O)₃(CH₂)₃—Si(CH₃)₂O(CH₃)₂Si—(CH₂)₃O(CH₂CH₂O)₃CH₃, CH₃O(CH₂CH₂O)₄(CH₂)₃—Si(CH₃)₂O(CH₃)₂Si—(CH₂)₃O(CH₂CH₂O)₄CH₃, CH₃O(CH₂CH₂O)₅(CH₂)₃—Si(CH₃)₂O(CH₃)₂Si—(CH₂)₃O(CH₂CH₂O)₅CH₃, CH₃O(CH₂CH₂O)₆(CH₂)₃—Si(CH₃)₂O(CH₃)₂Si—(CH₂)₃O(CH₂CH₂O)₆CH₃, CH₃O(CH₂CH₂O)₇(CH₂)₃Si(CH₃)₂O(CH₃)₂Si—(CH₂)₃O(CH₂CH₂O)₇CH₃, (CH₃)₃SiO(CH₃)₂Si—(CH₂)₃O(CH₂CH₂O)₂CH₃, (CH₃)₃SiO(CH₃)₂Si—(CH₂)₃O(CH₂CH₂O)₃CH₃, (CH₃)₃SiO(CH₃)₂Si—(CH₂)₃O(CH₂CH₂O)₄CH₃, (CH₃)₃SiO(CH₃)₂Si—(CH₂)₃O(CH₂CH₂O)₅CH₃, (CH₃)₃SiO(CH₃)₂Si—(CH₂)₃O(CH₂CH₂O)₆CH₃, (CH₃)₃SiO(CH₃)₂Si—(CH₂)₃O(CH₂CH₂O)₇CH₃; (CH₃)₃SiO(CH₃)₂Si—(CH₂)₂O(CH₂CH₂O)₂CH₃, (CH₃)₃SiO(CH₃)₂Si—(CH₂)₂O(CH₂CH₂O)₃CH₃, (CH₃)₃SiO(CH₃)₂Si—(CH₂)₂O(CH₂CH₂O)₄CH₃, (CH₃)₃SiO(CH₃)₂Si—(CH₂)₂O(CH₂CH₂O)₅CH₃, (CH₃)₃SiO(CH₃)₂Si—(CH₂)₂O(CH₂CH₂O)₆CH₃, (CH₃)₃SiO(CH₃)₂Si—(CH₂)₂O(CH₂CH₂O)₇CH₃; (CH₃)₃SiO(CH₃)₂SiO(CH₂CH₂O)₂CH₃, (CH₃)₃SiO(CH₃)₂SiO(CH₂CH₂O)₃CH₃, (CH₃)₃SiO(CH₃)₂SiO(CH₂CH₂O)₄CH₃, (CH₃)₃SiO(CH₃)₂SiO(CH₂CH₂O)₅CH₃, (CH₃)₃SiO(CH₃)₂SiO(CH₂CH₂O)₆CH₃, (CH₃)₃SiO(CH₃)₂SiO(CH₂CH₂O)₇CH₃, CH₃O(CH₂CH₂O)₂Si(CH₃)₂OSi(CH₃)₂O(CH₃)₂SiO(CH₂CH₂O)₂CH₃, CH₃O(CH₂CH₂O)₃Si(CH₃)₂OSi(CH₃)₂O(CH₃)₂SiO(CH₂CH₂O)₃CH₃, CH₃O(CH₂CH₂O)₄Si(CH₃)₂OSi(CH₃)₂O(CH₃)₂SiO(CH₂CH₂O)₄CH₃, CH₃O(CH₂CH₂O)₅Si(CH₃)₂OSi(CH₃)₂O(CH₃)₂SiO(CH₂CH₂O)₅CH₃, CH₃O(CH₂CH₂O)₆Si(CH₃)₂OSi(CH₃)₂O(CH₃)₂SiO(CH₂CH₂O)₆CH₃, CH₃O(CH₂CH₂O)₇Si(CH₃)₂OSi(CH₃)₂O(CH₃)₂SiO(CH₂CH₂O)₇CH₃; CH₃O(CH₂CH₂O)₂(CH₂)₃Si(CH₃)₂OSi(CH₃)₂O(CH₃)₂Si(CH₂)₃O(CH₃)₂SiO(CH₂CH₂O)₂CH₃, CH₃O(CH₂CH₂O)₃(CH₂)₃Si(CH₃)₂OSi(CH₃)₂O(CH₃)₂Si(CH₂)₃O(CH₃)₂SiO(CH₂CH₂O)₃CH₃, CH₃O(CH₂CH₂O)₄(CH₂)₃Si(CH₃)₂OSi(CH₃)₂O(CH₃)₂Si(CH₂)₃O(CH₃)₂SiO(CH₂CH₂O)₄CH₃, CH₃O(CH₂CH₂O)₅(CH₂)₃Si(CH₃)₂OSi(CH₃)₂O(CH₃)₂Si(CH₂)₃O(CH₃)₂SiO(CH₂CH₂O)₅CH₃; [(CH₃)₃SiO]₂Si(CH₃)O(CH₂CH₂O)₂CH₃, [(CH₃)₃SiO]₂Si(CH₃)O(CH₂CH₂O)₃CH₃, [(CH₃)₃SiO]₂Si(CH₃)O(CH₂CH₂O)₄CH₃, [(CH₃)₃SiO]₂Si(CH₃)O(CH₂CH₂O)₅CH₃, [(CH₃)₃SiO]₂Si(CH₃)O(CH₂CH₂O)₆CH₃, [(CH₃)₃SiO]₂Si(CH₃)O(CH₂CH₂O)₇CH₃, [(CH₃)₃SiO]₂Si(CH₃)(CH₂)₃O(CH₂CH₂O)₂CH₃, [(CH₃)₃SiO]₂Si(CH₃)(CH₂)₃O(CH₂CH₂O)₃CH₃, [(CH₃)₃SiO]₂Si(CH₃)(CH₂)₃O(CH₂CH₂O)₄CH₃, [(CH₃)₃SiO]₂Si(CH₃)(CH₂)₃O(CH₂CH₂O)₅CH₃, [(CH₃)₃SiO]₂Si(CH₃)(CH₂)₃O(CH₂CH₂O)₆CH₃, [(CH₃)₃SiO]₂Si(CH₃)(CH₂)₃O(CH₂CH₂O)₇CH₃, [(CH₃)₃SiO]₂Si(CH₃)O(CH₂CH₂O)₂(CH₃)Si[OSi(CH₃)₃]₂, [(CH₃)₃SiO]₂Si(CH₃)O(CH₂CH₂O)₃(CH₃)Si[OSi(CH₃)₃]₂, [(CH₃)₃SiO]₂Si(CH₃)O(CH₂CH₂O)₄(CH₃)Si[OSi(CH₃)₃]₂, [(CH₃)₃SiO]₂Si(CH₃)O(CH₂CH₂O)₅(CH₃)Si[OSi(CH₃)₃]₂, [(CH₃)₃SiO]₂Si(CH₃)O(CH₂CH₂O)₆(CH₃)Si[OSi(CH₃)₃]₂, [(CH₃)₃SiO]₂Si(CH₃)O(CH₂CH₂O)₇(CH₃)Si[OSi(CH₃)₃]₂, R—OSi(CH₃)₂OSi(CH₃)₂O(CH₃)₂SiO—R, R—OSi(CH₃)₂OSi(CH₃)₂OSi(CH₃)₃, RO(CH₂)₃Si(CH₃)₂OSi(CH₃)₂O(CH₃)₂Si(CH₂)₃—OR, RO(CH₂)₃Si(CH₃)₂OSi(CH₃)₂OSi(CH₃)₃, R—OSi(CH₃)₂OSi(CH₃)₂O(CH₃)₂SiO(CH₂CH₂)ₙCH₃, or RO(CH₂)₃Si(CH₃)₂OSi(CH₃)₂O(CH₃)₂Si(CH₂)₃O(CH₂CH₂)ₙCH₃, wherein
R is a carbonate group; n is 2, 3, 4, 5, 6, or 7;
n′ is 2, 3, 4, or 5;
p is 2, 3, or 4; and
p′ is 2 or 3.

8. The energy storage device of claim 1, wherein the viscosity reducing solvent comprises a fluorinated ether solvent.

9. The energy storage device of claim 8, wherein the fluorinated alkyl ether solvent comprises at least one of 1,1,2,2-tetrafluoroethyl-2,2,3,3-tetrafluoropropyl ether, 1,1,2,3,3,3-hexafluoropropyl-2,2,3,3-tetrafluoropropyl ether, 2,2,3,3,3-pentafluoropropyl-1,1,2,2-tetrafluoroethyl ether, 1,1,2,2-tetrafluoroethyl-2,2,2-trifluoroethyl ether, 1,1,2,2-tetrafluoroethyl-2,2,3,3-tetrafluoropropyl ether, methyl ether, tetrafluoropropyl-propylene carbonate-ether, 1,1,2,2-tetrafluoroethyl ethyl ether, 2-methyl tetrahydrofuran, 1,3-dioxolane, 1,4-dioxane, 1,2-dimethoxyethane, 1,2-diethoxyethane, 1,2-dibutoxyethane, methyl nonafluorobutyl ether, ethyl nonafluorobutyl ether, bis(2,2,2-trifluoroethyl) ether, 2-trifluoromethyl hexafluoropropyl methyl ether, 2-trifluoromethyl hexafluoropropyl ethyl ether, 2-trifluoromethyl hexafluoropropyl propyl ether, 3-trifluoro octafluorobutyl methyl ether, 3-trifluoro octafluorobutyl ethyl ether, 3-trifluoro octafluorobutyl propyl ether, 4-trifluorodecafluoropenthyl methyl ether, 4-trifluorodecafluoropenthyl ethyl ether, 4-trifluorodecafluoropenthyl propyl ether, 5-trifluorododecafluorohexyl methyl ether, 5-trifluorododecafluorohexyl ethyl ether, 5-trifluorododecafluorohexyl propyl ether, 6-trifluorotetradecafluoroheptyl methyl ether, 6-trifluorotetradecafluoroheptyl ethyl ether, 6-trifluorotetradecafluoroheptyl propyl ether, 7-trifluorohexadecafluorooctyl methyl ether, 7-trifluorohexadecafluorooctyl ethyl ether, and 7-trifluorohexadecafluorohexyl octyl ether, dimethoxy methane, 1,2-dimethoxy ethane, digryme, trigryme, 1,3-dioxolane, and tetrahydrofuran.

10. An electrolyte composition suitable for use in an energy storage device comprising an anode and a cathode, the electrolyte composition comprising:
a room temperature ionic liquid solvent and at least one wetting agent or viscosity reducing co-solvent and mixtures thereof.

11. The energy storage device of claim 10, wherein the viscosity reducing solvent comprises a functionalized pyrrolidinum cation.

12. The energy storage device of claim 11, wherein one or more of the atoms in the heterocyclic ring of the pyrrolidinium cation is substituted with one or more moieties selected from the group consisting of halides, oxygen, nitrogen, sulfur, phosphorus, alkanes, esters, ethers, ketones, carbonyls, alkoxyalkanes, alkenes, alkynes, aryls, nitriles, silanes, sulfones, thiols, phenols, hydroxyls, amines, imides, aldehydes, carboxylic acids, carbonates, and acid anhydrides; and
wherein any of the carbon or hydrogen atoms in the above moieties are further substituted with halides, oxygen, nitrogen, sulfur, phosphorus, alkanes, esters, ethers, ketones, carbonyls, alkoxyalkanes, alkenes, alkynes, aryls, nitriles, silanes, sulfones, thiols, phenols, hydroxyls, amines, imides, aldehydes, carboxylic acids, carbonates, and acid anhydrides.

13. The energy storage device of claim 10, wherein the viscosity reducing solvent comprises a silane or siloxane solvent.

14. The energy storage device of claim 13, wherein the silane or siloxane solvent comprises at least one of phenyltrimethoxysilane, ethyltrimethoxysilane, pentafluorophenyltrimethoxylsilane, and phenethyltris(trimethylsiloxy)silane, Tris(pentafluorophenyl)silane, tris(trimethylsilyl)phosphate, tris(trimethylsilyl)phosphite, tris(trimethylsilyl)borate, bis(methoxytriethyleneoxypropyl)-tetramethyldisiloxane, silanes the of the formulae:
(CH₃)₃SiO(CH₂CH₂O)₂CH₃, (CH₃)₃SiO(CH₂CH₂O)₃CH₃, (CH₃)₃SiO(CH₂CH₂O)₄CH₃, (CH₃)₃SiO(CH₂CH₂O)₅CH₃, (CH₃)₃SiO(CH₂CH₂O)₆CH₃, (CH₃)₃SiO(CH₂CH₂O)₇CH₃; (CH₃)₃SiCH₂O(CH₂CH₂O)₂CH₃, (CH₃)₃SiCH₂O(CH₂CH₂O)₃CH₃, (CH₃)₃SiCH₂O(CH₂CH₂O)₄CH₃, (CH₃)₃SiCH₂O(CH₂CH₂O)₅CH₃, (CH₃)₃SiCH₂O(CH₂CH₂O)₆CH₃, (CH₃)₃SiCH₂O(CH₂CH₂O)₇CH₃; (CH₃)₃Si(CH₂)₃O(CH₂CH₂O)₂CH₃, (CH₃)₃Si(CH₂)₃O(CH₂CH₂O)₃CH₃, (CH₃)₃Si(CH₂)₃O(CH₂CH₂O)₄CH₃, (CH₃)₃Si(CH₂)₃O(CH₂CH₂O)₅CH₃, (CH₃)₂Si[O(CH₂CH₂O)₂CH₃]₂, (CH₃)₂Si[O(CH₂CH₂O)₃CH₃]₂, (CH₃)₂Si[O(CH₂CH₂O)₄CH₃]₂, (CH₃)₂Si[O(CH₂CH₂O)₅CH₃]₂; CH₃Si[O(CH₂CH₂O)₂CH₃]₃, CH₃Si[O(CH₂CH₂O)₃CH₃]₃, CH₃Si[O(CH₂CH₂O)₄CH₃]₃; Si[O(CH₂CH₂O)₂CH₃]₄, Si[O(CH₂CH₂O)₃CH₃]₄, (CH₃)₂Si[O(CH₂CH₂O)₂CH₃][(CH₂)₃⁰(CH₂CH₂O)₂CH₃], (CH₃)₂Si[O(CH₂CH₂O)₃CH₃][(CH₂)₃O(CH₂CH₂O)₃CH₃], (CH₃)₂Si[O(CH₂CH₂O)₄CH₃][(CH₂)₃O(CH₂CH₂O)₄CH₃], (CH₃)₂Si[O(CH₂CH₂O)₅CH₃][(CH₂)₃O(CH₂CH₂O)₅CH₃],
and siloxanes of the formulae:
(CH₃)₃SiO(CH₂CH₂O)ₙCH₃, (CH₃)₃SiCH₂O(CH₂CH₂O)ₙCH₃; (CH₃)₃Si(CH₂)₃O(CH₂CH₂O)_{n′}CH₃; (CH₃)₂Si[O(CH₂CH₂O)_{n′}CH₃]₂; CH₃Si[O(CH₂CH₂O)ₚCH₃]₃, Si[O(CH₂CH₂O)ₚCH₃]₄; (CH₃)₂Si[O(CH₂CH₂O)_{n′}CH₃][(CH₂)₃O(CH₂CH₂O)_{n′}CH₃]; (CH₃)₃SiOR; (CH₃)₃Si(CH₂)₃OR; CH₃O(CH₂CH₂O)ₙSi(CH₃)₂O(CH₃)₂SiO(CH₂CH₂O)ₙCH₃, CH₃O(CH₂CH₂O)ₙCH₂Si(CH₃)₂O(CH₃)₂SiCH₂O(CH₂CH₂O)ₙCH₃, CH₃O(CH₂CH₂O)ₙ(CH₂)₃Si(CH₃)₂O(CH₃)₂Si(CH₂)₃O(CH₂CH₂O)ₙCH₃, (CH₃)₃SiO(CH₃)₂Si(CH₂)₃O(CH₂CH₂O)ₙCH₃, (CH₃)₃SiO(CH₃)₂Si(CH₂)₂O(CH₂CH₂O)ₙCH₃, (CH₃)₃SiO(CH₃)₂SiO(CH₂CH₂O)ₙCH₃, (CH₃)₃SiO(CH₃)₂SiOR; ROSi(CH₃)₂O(CH₃)₂SiO—R; (CH₃)₃SiO(CH₃)₂Si(CH₂)₃OR; RO(CH₂)₃Si(CH₃)₂O(CH₃)₂Si(CH₂)₃OR; CH₃O(CH₂CH₂O)ₙSi(CH₃)₂OSi(CH₃)₂O(CH₃)₂SiO(CH₂CH₂O)ₙCH₃, CH₃O(CH₂CH₂O)_{n′}(CH₂)₃Si(CH₃)₂OSi(CH₃)₂O(CH₃)₂Si(CH₂)₃O(CH₃)₂Si—(OCH₂CH₂)_{n′}OCH₃, [(CH₃)₃SiO]₂Si(CH₃)O(CH₂CH₂O)ₙCH₃, [(CH₃)₃SiO]₂Si(CH₃)(CH₂)₃O(CH₂CH₂O)ₙCH₃, [(CH₃)₃SiO]₂Si(CH₃)O(CH₂CH₂O)ₙ(CH₃)Si[OSi(CH₃)₃]₂, ROSi(CH₃)₂OSi(CH₃)₂O(CH₃)₂SiOR, ROSi(CH₃)₂OSi(CH₃)₂OSi(CH₃)₃, RO(CH₂)₃Si(CH₃)₂OSi(CH₃)₂O(CH₃)₂Si(CH₂)₃OR, RO(CH₂)₃Si(CH₃)₂OSi(CH₃)₂OSi(CH₃)₃; ROSi(CH₃)₂OSi(CH₃)₂O(CH₃)₂SiO(CH₂CH₂)ₙCH₃, or RO(CH₂)₃Si(CH₃)₂OSi(CH₃)₂O(CH₃)₂Si(CH₂)₃O(CH₂CH₂)ₙCH₃, CH₃O(CH₂CH₂O)₂Si(CH₃)₂O(CH₃)₂SiO(CH₂CH₂O)₂CH₃, CH₃O(CH₂CH₂O)₃Si(CH₃)₂O(CH₃)₂SiO(CH₂CH₂O)3CH₃, CH3O(CH₂CH₂O)₄Si(CH₃)₂O(CH₃)₂SiO(CH₂CH₂O)₄CH₃, CH₃O(CH₂CH₂O)₅Si(CH₃)₂O(CH₃)₂SiO(CH₂CH₂O)₅CH₃, CH₃O(CH₂CH₂O)₆Si(CH₃)₂O(CH₃)₂SiO(CH₂CH₂O)₆CH₃, CH₃O(CH₂CH₂O)₇Si(CH₃)₂O(CH₃)₂SiO(CH₂CH₂O)₇CH₃; CH₃O(CH₂CH₂O)₂CH₂—Si(CH₃)₂O(CH₃)₂Si—CH₂O(CH₂CH₂O)₂CH₃, CH₃O(CH₂CH₂O)₂CH₂Si(CH₃)₃O(CH₃)₂Si—CH₂O(CH₂CH₂O)₃CH₃, CH₃O(CH₂CH₂O)₄CH₂Si(CH₃)₂O(CH₃)₂SiCH₂O(CH₂CH₂O)₄CH₃, CH₃O(CH₂CH₂O)₅CH₂Si(CH₃)₂O(CH₃)₂SiCH₂O(CH₂CH₂O)₅CH₃, CH₃O(CH₂CH₂O)₆CH₂—Si(CH₃)₂O(CH₃)₂SiCH₂O(CH₂CH₂O)₆CH₃, CH₃O(CH₂CH₂O)₇CH₂Si(CH₃)₂O(CH₃)₂Si—CH₂O(CH₂CH₂O)₇CH₃; CH₃O(CH₂CH₂O)₂(CH₂)₃Si(CH₃)₂O(CH₃)₂Si—(CH₂)₃O(CH₂CH₂O)₂CH₃, CH₃O(CH₂CH₂O)₃(CH₂)₃—Si(CH₃)₂O(CH₃)₂Si—(CH₂)₃O(CH₂CH₂O)₃CH₃, CH₃O(CH₂CH₂O)₄(CH₂)₃—Si(CH₃)₂O(CH₃)₂Si—(CH₂)₃O(CH₂CH₂O)₄CH₃, CH₃O(CH₂CH₂O)₅(CH₂)₃—Si(CH₃)₂O(CH₃)₂Si—(CH₂)₃O(CH₂CH₂O)₅CH₃, CH₃O(CH₂CH₂O)₆(CH₂)₃—Si(CH₃)₂O(CH₃)₂Si—(CH₂)₃O(CH₂CH₂O)₆CH₃, CH₃O(CH₂CH₂O)₇(CH₂)₃Si(CH₃)₂O(CH₃)₂Si—(CH₂)₃O(CH₂CH₂O)₇CH₃; (CH₃)₃SiO(CH₃)₂Si—(CH₂)₃O(CH₂CH₂O)₂CH₃, (CH₃)₃SiO(CH₃)₂Si—(CH₂)₃O(CH₂CH₂O)₃CH₃, (CH₃)₃SiO(CH₃)₂Si—(CH₂)₃O(CH₂CH₂O)₄CH₃, (CH₃)₃SiO(CH₃)₂Si—(CH₂)₃O(CH₂CH₂O)₅CH₃, (CH₃)₃SiO(CH₃)₂Si—(CH₂)₃O(CH₂CH₂O)₆CH₃, (CH₃)₃SiO(CH₃)₂Si—(CH₂)₃O(CH₂CH₂O)₇CH₃; (CH₃)₃SiO(CH₃)₂Si—(CH₂)₂O(CH₂CH₂O)₂CH₃, (CH₃)₃SiO(CH₃)₂Si—(CH₂)₂O(CH₂CH₂O)₃CH₃, (CH₃)₃SiO(CH₃)₂Si—(CH₂)₂O(CH₂CH₂O)₄CH₃, (CH₃)₃SiO(CH₃)₂Si—(CH₂)₂O(CH₂CH₂O)₅CH₃, (CH₃)₃SiO(CH₃)₂Si—(CH₂)₂O(CH₂CH₂O)₆CH₃, (CH₃)₃SiO(CH₃)₂Si—(CH₂)₂O(CH₂CH₂O)₇CH₃; (CH₃)₃SiO(CH₃)₂SiO(CH₂CH₂O)₂CH₃, (CH₃)₃SiO(CH₃)₂SiO(CH₂CH₂O)₃CH₃, (CH₃)₃SiO(CH₃)₂SiO(CH₂CH₂O)₄CH₃, (CH₃)₃SiO(CH₃)₂SiO(CH₂CH₂O)₅CH₃, (CH₃)₃SiO(CH₃)₂SiO(CH₂CH₂O)₆CH₃, (CH₃)₃SiO(CH₃)₂SiO(CH₂CH₂O)₇CH₃, CH₃O(CH₂CH₂O)₂Si(CH₃)₂OSi(CH₃)₂O(CH₃)₂SiO(CH₂CH₂O)₂CH₃, CH₃O(CH₂CH₂O)₃Si(CH₃)₂OSi(CH₃)₂O(CH₃)₂SiO(CH₂CH₂O)₃CH₃, CH₃O(CH₂CH₂O)₄Si(CH₃)₂OSi(CH₃)₂O(CH₃)₂SiO(CH₂CH₂O)₄CH₃, CH₃O(CH₂CH₂O)₅Si(CH₃)₂OSi(CH₃)₂O(CH₃)₂SiO(CH₂CH₂O)₅CH₃, CH₃O(CH₂CH₂O)₆Si(CH₃)₂OSi(CH₃)₂O(CH₃)₂SiO(CH₂CH₂O)₆CH₃, CH₃O(CH₂CH₂O)₇Si(CH₃)₂OSi(CH₃)₂O(CH₃)₂SiO(CH₂CH₂O)₇CH₃; CH₃O(CH₂CH₂O)₂(CH₂)₃Si(CH₃)₂OSi(CH₃)₂O(CH₃)₂Si(CH₂)₃O(CH₃)₂SiO(CH₂CH₂O)₂CH₃, CH₃O(CH₂CH₂O)₃(CH₂)₃Si(CH₃)₂OSi(CH₃)₂O(CH₃)₂Si(CH₂)₃O(CH₃)₂SiO(CH₂CH₂O)₃CH₃, CH₃O(CH₂CH₂O)₄(CH₂)₃Si(CH₃)₂OSi(CH₃)₂O(CH₃)₂Si(CH₂)₃O(CH₃)₂SiO(CH₂CH₂O)₄CH₃, CH₃O(CH₂CH₂O)₅(CH₂)₃Si(CH₃)₂OSi(CH₃)₂O(CH₃)₂Si(CH₂)₃O(CH₃)₂SiO(CH₂CH₂O)₅CH₃; [(CH₃)₃SiO]₂Si(CH₃)O(CH₂CH₂O)₂CH₃, [(CH₃)₃SiO]₂Si(CH₃)O(CH₂CH₂O)₃CH₃, [(CH₃)₃SiO]₂Si(CH₃)O(CH₂CH₂O)₄CH₃, [(CH₃)₃SiO]₂Si(CH₃)O(CH₂CH₂O)₅CH₃, [(CH₃)₃SiO]₂Si(CH₃)O(CH₂CH₂O)₆CH₃, [(CH₃)₃SiO]₂Si(CH₃)O(CH₂CH₂O)₇CH₃, [(CH₃)₃SiO]₂Si(CH₃)(CH₂)₃O(CH₂CH₂O)₂CH₃, [(CH₃)₃SiO]₂Si(CH₃)(CH₂)₃O(CH₂CH₂O)₃CH₃, [(CH₃)₃SiO]₂Si(CH₃)(CH₂)₃O(CH₂CH₂O)₄CH₃, [(CH₃)₃SiO]₂Si(CH₃)(CH₂)₃O(CH₂CH₂O)₅CH₃, [(CH₃)₃SiO]₂Si(CH₃)(CH₂)₃O(CH₂CH₂O)₆CH₃, [(CH₃)₃SiO]₂Si(CH₃)(CH₂)₃O(CH₂CH₂O)₇CH₃, [(CH₃)₃SiO]₂Si(CH₃)O(CH₂CH₂O)₂(CH₃)Si[OSi(CH₃)₃]₂, [(CH₃)₃SiO]₂Si(CH₃)O(CH₂CH₂O)₃(CH₃)Si[OSi(CH₃)₃]₂, [(CH₃)₃SiO]₂Si(CH₃)O(CH₂CH₂O)₄(CH₃)Si[OSi(CH₃)₃]₂, [(CH₃)₃SiO]₂Si(CH₃)O(CH₂CH₂O)₅(CH₃)Si[OSi(CH₃)₃]₂, [(CH₃)₃SiO]₂Si(CH₃)O(CH₂CH₂O)₆(CH₃)Si[OSi(CH₃)₃]₂, [(CH₃)₃SiO]₂Si(CH₃)O(CH₂CH₂O)₇(CH₃)Si[OSi(CH₃)₃]₂, R—OSi(CH₃)₂OSi(CH₃)₂O(CH₃)₂SiO—R, R—OSi(CH₃)₂OSi(CH₃)₂OSi(CH₃)₃, RO(CH₂)₃Si(CH₃)₂OSi(CH₃)₂O(CH₃)₂Si(CH₂)₃O—R, RO(CH₂)₃Si(CH₃)₂OSi(CH₃)₂OSi(CH₃)₃, R—OSi(CH₃)₂OSi(CH₃)₂O(CH₃)₂SiO(CH₂CH₂)ₙCH₃, or RO(CH₂)₃Si(CH₃)₂OSi(CH₃)₂O(CH₃)₂Si(CH₂)₃O(CH₂CH₂)ₙCH₃, wherein
R is a carbonate group; n is 2, 3, 4, 5, 6, or 7;
n′ is 2, 3, 4, or 5;
p is 2, 3, or 4; and
p′ is 2 or 3.

15. The energy storage device of claim 10, wherein the viscosity reducing solvent comprises a fluorinated ether solvent.

16. The energy storage device of claim 15, wherein the fluorinated alkyl ether solvent comprises at least one of 1,1,2,2-tetrafluoroethyl-2,2,3,3-tetrafluoropropyl ether, 1,1,2,3,3,3-hexafluoropropyl-2,2,3,3-tetrafluoropropyl ether, 2,2,3,3,3-pentafluoropropyl-1,1,2,2-tetrafluoroethyl ether, 1,1,2,2-tetrafluoroethyl-2,2,2-trifluoroethyl ether, 1,1,2,2-tetrafluoroethyl-2,2,3,3-tetrafluoropropyl ether, methyl ether, tetrafluoropropyl-propylene carbonate-ether, 1,1,2,2-tetrafluoroethyl ethyl ether, 2-methyl tetrahydrofuran, 1,3-dioxolane, 1,4-dioxane, 1,2-dimethoxyethane, 1,2-diethoxyethane, 1,2-dibutoxyethane, methyl nonafluorobutyl ether, ethyl nonafluorobutyl ether, bis(2,2,2-trifluoroethyl) ether, 2-trifluoromethyl hexafluoropropyl methyl ether, 2-trifluoromethyl hexafluoropropyl ethyl ether, 2-trifluoromethyl hexafluoropropyl propyl ether, 3-trifluoro octafluorobutyl methyl ether, 3-trifluoro octafluorobutyl ethyl ether, 3-trifluoro octafluorobutyl propyl ether, 4-trifluorodecafluoropenthyl methyl ether, 4-trifluorodecafluoropenthyl ethyl ether, 4-trifluorodecafluoropenthyl propyl ether, 5-trifluorododecafluorohexyl methyl ether, 5-trifluorododecafluorohexyl ethyl ether, 5-trifluorododecafluorohexyl propyl ether, 6-trifluorotetradecafluoroheptyl methyl ether, 6-trifluorotetradecafluoroheptyl ethyl ether, 6-trifluorotetradecafluoroheptyl propyl ether, 7-trifluorohexadecafluorooctyl methyl ether, 7-trifluorohexadecafluorooctyl ethyl ether, and 7-trifluorohexadecafluorohexyl octyl ether, dimethoxy methane, 1,2-dimethoxy ethane, digryme, trigryme, 1,3-dioxolane, and tetrahydrofuran.
